(19) United States
(12) Patent Application Publication
(10) Pub. No.: US 2022/0311759 A1
(43) Pub. Date: Sep. 29, 2022

(54) INFORMATION PROCESSING APPARATUS, INFORMATION PROCESSING METHOD, AND NON-TRANSITORY RECORDING MEDIUM

(71) Applicant: Birei Jo, Kanagawa (JP)

(72) Inventor: Birei Jo, Kanagawa (JP)

(73) Assignee: Ricoh Company, Ltd., Tokyo (JP)

(21) Appl. No.: 17/655,231

(22) Filed: Mar. 17, 2022

(30) Foreign Application Priority Data
Mar. 23, 2021 (JP) 2021-048405
Mar. 10, 2022 (JP) 2022-037031

(51) Int. Cl. H04L 9/40

(52) U.S. Cl. CPC H04L 63/083; H04L 63/102; H04L 63/20

(57) ABSTRACT

An information processing apparatus includes a memory that stores, for each of a plurality of types of recording medium used for user authentication, authentication server identification information identifying an authentication server to perform user authentication using the recording medium in association with medium type information of the recording medium and circuitry to read, from a recording medium used for user authentication, medium identification information identifying the recording medium and medium type information indicating a type of the recording medium, identify an authentication server to perform user authentication based on authentication server identification information stored in the memory in association with the read medium type information, generate an authentication request for requesting the user authentication to the identified authentication server, the authentication request including the read medium identification information, and transmit the generated authentication request to the identified authentication server via a network.

### CROSS-REFERENCE TO RELATED APPLICATIONS

This patent application is based on and claims priority pursuant to 35 U.S.C. § 119(a) to Japanese Patent Application Nos. 2021-048405, filed on Mar. 23, 2021, and 2022-037031, filed on Mar. 10, 2022, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

A multifunction peripheral (MFP) known in the art, which is an example of an information processing apparatus, is connected to only one authentication server. In such a case, by transmitting identification information to the authentication server, a group of specific functions of the multifunction peripheral is authorized to be used after the authentication server successfully performs user authentication. That is, one authentication server authorizes at least one or more specific functions to be used for a user as a customized function group from all functions such as printing, scanning, facsimile communication, and copying that the multifunction peripheral has. For this reason, in order to make another group of functions (i.e., a different combination of functions) usable in the multifunction peripheral, it is necessary to uninstall once the group of functions that has been already authorized to be used and then install newly the other group of functions authorized to be used. As described above, in the conventional multifunction peripheral, a plurality of different customized function groups authorized to be used does not coexist. For this reason, only one customized function group authorized to be used is usable in the multifunction peripheral and thus no other customized function groups to be authorized to use are usable in the multifunction peripheral.

### SUMMARY

In one aspect, an information processing apparatus includes a memory that stores, for each of a plurality of types of recording medium used for user authentication, authentication server identification information identifying an authentication server to perform user authentication using the recording medium in association with medium type information of the recording medium and circuitry to read, from a recording medium used for user authentication, medium identification information identifying the recording medium and medium type information indicating a type of the recording medium, identify an authentication server to perform user authentication based on authentication server identification information stored in the memory in association with the read medium type information, generate an authentication request for requesting the user authentication to the identified authentication server, the authentication request including the read medium identification information, and transmit the generated authentication request to the identified authentication server via a network.

In another aspect, an information processing method, the method includes reading, from a recording medium used for user authentication, medium identification information identifying the recording medium and medium type information indicating a type of the recording medium, identifying an authentication server to perform user authentication, based on authentication server identification information stored in a memory in association with the read medium type information of the recording medium, generating an authentication request for requesting the user authentication to the identified authentication server, the authentication request including the read medium identification information, and transmitting the generated authentication request to the identified authentication server via a network.

In another aspect, a non-transitory recording medium is provided, which stores a plurality of program codes which, when executed by one or more processors, causes the processors to perform the above-described method.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a system configuration including an information processing apparatus and a plurality of authentication servers according to one embodiment of the present disclosure;

FIG. 2 is a block diagram illustrating an example of a hardware configuration of the plurality of authentication servers that communicates with the information processing apparatus according to one embodiment of the present disclosure;

FIG. 3 is a block diagram illustrating an example of a hardware configuration of an image forming apparatus, which is an example of the information processing apparatus, according to one embodiment of the present disclosure;

FIG. 4 is a block diagram illustrating an example of a software configuration of the image forming apparatus, which is an example of the information processing apparatus, according to one embodiment of the present disclosure;

FIG. 5 is a block diagram illustrating an example of a functional configuration of the information processing apparatus according to one embodiment of the present disclosure;

FIG. 6 is a flowchart illustrating an example of an operation procedure performed by the information processing apparatus according to one embodiment of the present disclosure;

FIG. 7 is a table, which an authentication-server identifying unit refers to, illustrating a relationship among authentication customization type information, medium type information, authentication server identification information, and function identification information according to one embodiment of the present disclosure;

FIGS. 8A and 8B are diagrams each illustrating an example of a screen displayed on an operation panel of the information processing apparatus according to one embodiment of the present disclosure;

FIG. 9 is a schematic diagram illustrating an overview of an operation performed by the information processing apparatus according to one embodiment of the present disclosure; and

FIG. 10 is a table, which the authentication-server identifying unit refers to, illustrating a relationship among the authentication customization type information, authentication information input form, the authentication server identification information, and the function identification information according to a variation of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a,” “an,” and “the” are intended to include the plural forms as well, unless the context clearly indicates otherwise.

According to the present disclosure, an authentication server to perform user authentication is selected from a plurality of authentication servers in the following configuration. An information processing apparatus according to embodiments of the present disclosure is connected to a plurality of authentication servers via a network and includes a memory, a reading unit, an authentication-server identifying unit, an authentication-request generating unit, and a communication unit. The memory stores, for each of a plurality of types of recording medium used for user authentication, authentication server identification information identifying an authentication server to perform user authentication using the recording medium in association with medium type information of the recording medium. The reading unit reads, from a recording medium used for user authentication, medium identification information identifying the recording medium and medium type information indicating a type of the recording medium. The authentication-server identifying unit identifies an authentication server to perform user authentication based on authentication server identification information stored in the memory in association with the read medium type information. The authentication-request generating unit generates an authentication request for requesting the user authentication to the identified authentication server, the authentication request including the read medium identification information. The communication unit transmits the generated authentication request to the identified authentication server via the network.

Descriptions are given of the characteristics of the present disclosure with reference to the drawings. However, elements, types, combinations of elements, shapes of the elements, and relative positions of elements in the embodiments are examples and do not limit the scope of appended claims. Hereinafter, embodiments of the present disclosure are described with reference to the drawings.

System Configuration

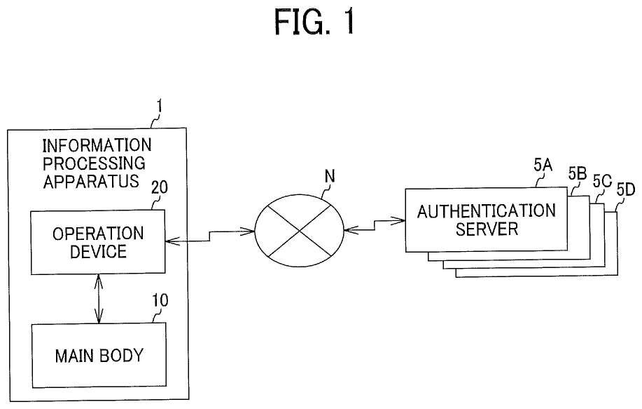

FIG. 1 is a diagram illustrating a configuration of a system including an information processing apparatus and a plurality of authentication servers according to the present embodiment. As illustrated in FIG. 1, the system includes an information processing apparatus 1, an authentication server 5A, an authentication server 5B, an authentication server 5C, and an authentication server 5D. The information processing apparatus 1 communicates with each of the authentication servers via a network N. The information processing apparatus 1 is, for example, an image forming apparatus, and includes an operation device 20 and a main body 10. The operation device 20 reads medium identification information and medium type information from a card (an example of a recording medium for user authentication). The operation device 20 selects one of the authentication servers 5A to 5D based on the medium type information and causes the selected authentication server to perform user authentication by transmitting the medium identification information to the selected authentication server. In response to receiving a result of the user authentication from the selected authentication server, the operation device 20 makes a customized function group usable on the main body 10. In response to receiving the medium identification information from the operation device 20 of the information processing apparatus 1, each of the authentication servers 5A to 5D performs the user authentication by comparing the medium identification information with information for the user authentication stored in advance and transmits the result of the user authentication to the information processing apparatus 1.

Hardware Configuration of Authentication Servers

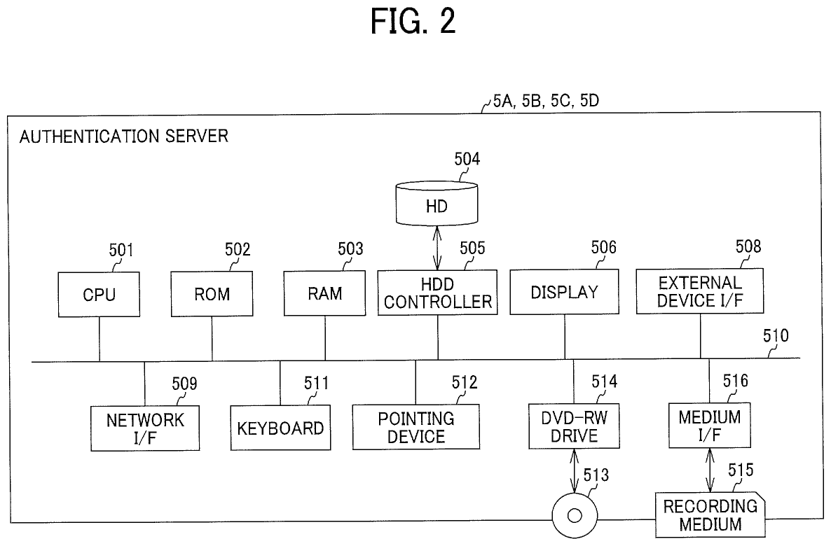

FIG. 2 is a block diagram illustrating an example of a hardware configuration common to the plurality of authentication servers that communicates with the information processing apparatus according to the present embodiment. Each of the plurality of authentication servers according to one embodiment may be a personal computer. A description is now given of a hardware configuration common to the authentication servers 5A to 5D. As illustrated in FIG. 2, each of the authentication servers 5A to 5D is implemented by a computer and includes a central processing unit (CPU) 501, a read only memory (ROM) 502, a random access memory (RAM) 503, a hard disk (HD) 504, a hard disk drive (HDD) controller 505, a display 506, an external device interface (I/F) 508, a network I/F 509, a data bus 510, a keyboard 511, a pointing device 512, a digital versatile disc rewritable (DVD-RW) drive 514, and a medium I/F 516.

The CPU 501 controls entire operation of one of the authentication servers 5A to 5D to which the CPU 501 belongs. Hereinafter, one of the authentication servers 5A to 5D may be referred to as “authentication server 5” when discrimination is not necessary. The ROM 502 stores programs such as an initial program loader (IPL) to boot the CPU 501. The RAM 503 is used as a work area for the CPU 501. The HD 504 stores various data such as a control program. The HDD controller 505 controls reading and writing of various data from and to the HD 504 under control of the CPU 501. The display 506 displays various information such as a cursor, a menu, a window, characters, or an image. The external device I/F 508 is an interface for connection with various external devices. Examples of the external devices include, but not limited to, a universal serial bus (USB) memory and a printer. The network I/F 509 is an interface for data communication through the network N. The data bus 510 is an address bus, a data bus, or the like that electrically connects each component, such as the CPU 501, illustrated in FIG. 2.

The keyboard 511 is an example of an input device provided with a plurality of keys that allows a user to input characters, numerals, and various instructions. The pointing device 512 is an example of an input device that allows a user to select or execute various instructions, select an object for processing, and move a cursor being displayed. The DVD-RW drive 514 controls reading and writing of various data from and to a DVD-RW 513, which is an example of a removable storage medium. The removable recording medium is not limited to a DVD-RW and may be a digital versatile disc recordable (DVD-R) or the like. The medium I/F 516 controls reading and writing (storing) of data from and to a recording medium 515 such as a flash memory.

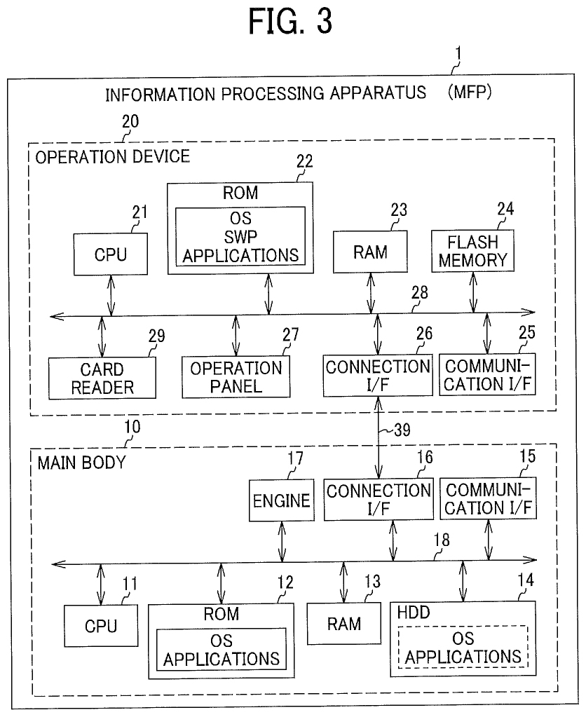

Hardware Configuration of Image Forming Apparatus FIG. 3 is a block diagram illustrating an example of a hardware configuration of an image forming apparatus (MFP), which is an example of the information processing apparatus, according to the present embodiment. A description is given of the hardware configuration of the information processing apparatus 1 according to the present embodiment. As illustrated in FIG. 3, the MFP as the information processing apparatus 1 includes the main body 10 having various functions such as copying, scanning, facsimile communication, and printing, and the operation device 20 that receives an input in accordance with a user operation. The main body 10 and the operation device 20 are connected to each other via a dedicated communication path 39. The dedicated communication path 39 may be in compliance with a USB standard. However, any other standard, regardless of wired or wireless, may be used as the dedicated communication path 39. A CPU 11 of the main body 10 controls entire operation of the main body 10 by executing programs stored in a ROM 12 or an HDD 14, etc., using a RAM 13 as a work area, to implement various functions such as copying, scanning, facsimile communication, and printing as described above. An engine 17 is hardware that performs processing other than general-purpose information processing and communications. For example, the engine 17 performs processing for implementing the functions of copying, scanning, facsimile communication, and printing. In response to an occurrence of an event generating a log, a log data is stored in a log data storage device (the HDD 14 or the RAM 13) of the MFP. Normally the log data is stored in an HDD of an apparatus. In a case where the apparatus does not include an HDD, the log data is stored in a RAM.

The main body 10 further includes a communication I/F 15, a connection I/F 16, and a system bus 18.

The operation device 20 includes a CPU 21, a ROM 22, a RAM 23, a flash memory 24, a communication I/F 25, a connection I/F 26, an operation panel 27, and a card reader 29, which are connected with one another via a system bus 28. The operation panel 27 is a so-called touch panel including a liquid crystal display (LCD) integral with a touch sensor formed of transparent electrodes. The operation panel 27 receives various inputs in accordance with a touch operation by a user and displays various pieces of information such as information in accordance with the received inputs, information indicating an operation status of the MFP, and information indicating a setting status. The card reader 29 reads information stored in a portable recording medium (a card) such as an integrated circuit (IC) card. The information stored in the card is, for example, the medium identification information for uniquely identifying the IC card, and the medium type information indicating the type of the card.

Software Configuration of Image Forming Apparatus

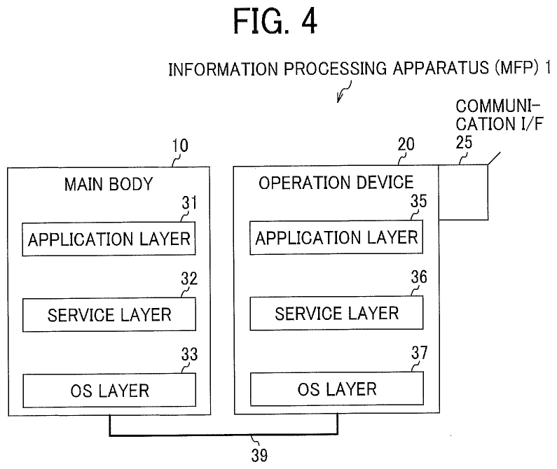

FIG. 4 is a block diagram illustrating an example of a software configuration of the image forming apparatus, which is an example of the information processing apparatus, according to the present embodiment. As illustrated in FIG. 4, the main body 10 includes an application layer 31, a service layer 32, and an operating system (OS) layer 33. The substance of the application layer 31, the service layer 32, and the OS layer 33 is various software stored in the ROM 12 (or the HDD 14). The CPU 11 executes the various software to provide various functions. The operation device 20 includes an application layer 35, a service layer 36, and an OS layer 37. The application layer 35, the service layer 36 and the OS layer 37 of the operation device 20 are substantially similar in function to those of the main body 10. However, functions provided by applications of the application layer 35 and operation requests to be received by the service layer 36 are different from those of the main body 10. The applications of the application layer 35 may be software for causing the hardware resources of the operation device 20 to operate so as to provide particular functions. The applications of the application layer 35 are mainly software for providing a user interface (UI) for performing operations and displaying relating to functions that the main body 10 has, such as functions of copying, scanning, facsimile communication, and printing.

In the present embodiment, the image forming apparatus (the information processing apparatus 1) includes, for example, four types of authentication customization type information as a customized function group setting that indicates the functions authorized to be used for an individual user U. The four types of authentication customization type information are, for example, a standard authentication, a customized authentication A, a customized authentication B, and a simple card authentication. For the standard authentication, the functions of copying and scanning are provided, for example. For the customized authentication A, the functions of copying, scanning, and facsimile communication are provided. For the customized authentication B, the functions of copying, scanning, and printing are provided. For the simple card authentication, the function of copying is provided. The authentication customization type information indicates one or more functions that are authorized to be used for the individual user U. Note that the authentication server that performs the user authentication is different for each type of the authentication customization type information.

Functional Configuration

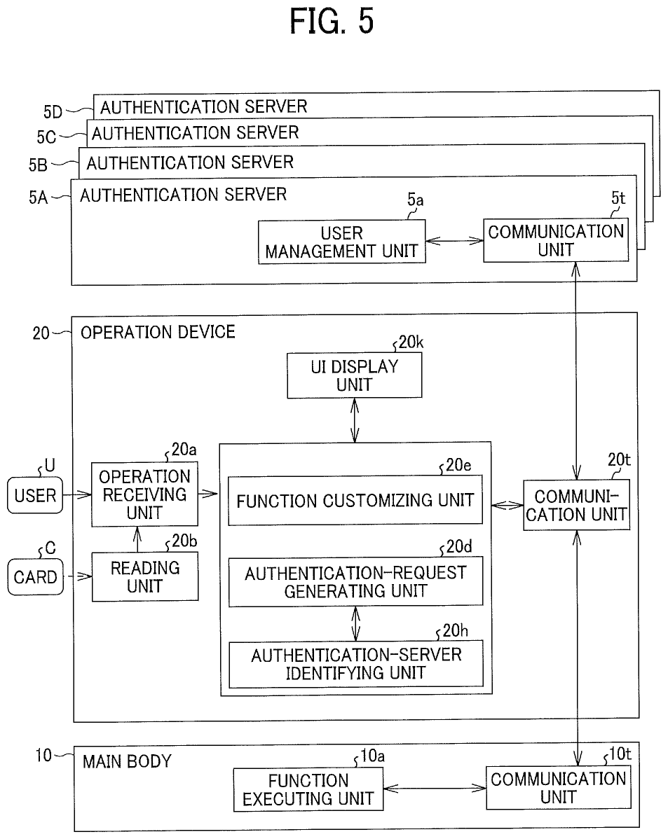

FIG. 5 is a block diagram illustrating an example of a functional configuration of the information processing apparatus according to the present embodiment. As illustrated in FIG. 5, the operation device 20, the main body 10, and the authentication servers 5A to 5D are arranged in the block diagram illustrating the functional configuration. In this functional block diagram, four authentication servers are provided for the sake of simple description, but the number of the authentication servers, which corresponds to the number of the authentication customization types, is not limited to four.

Operation Device

The operation device 20 includes an operation receiving unit 20a, a reading unit 20b, a UI display unit 20k, a communication unit 20t, an authentication-server identifying unit 20h, an authentication-request generating unit 20d, and a function customizing unit 20e. The operation receiving unit 20a receives a user operation and transmits information input in accordance with the user operation to the authentication-request generating unit 20d. The reading unit 20b, using the card reader 29, reads the medium identification information for uniquely identifying a card C (a recording medium) and the medium type information for indicating the type of the card C from the card C. The reading unit 20b transmits the read medium identification information and the medium type information to the authentication-server identifying unit 20h. The communication unit 20t transmits and receives data (information) to and from each of the authentication servers 5A to 5D via the network N. The information transmitted and received at this time includes, for example, an authentication request that is a request for user authentication, and a response (a success or a failure) to the authentication request. In addition, the communication unit 20t transmits and receives data (information) to and from the main body 10. Further, the communication unit 20t communicates with external devices via the network N.

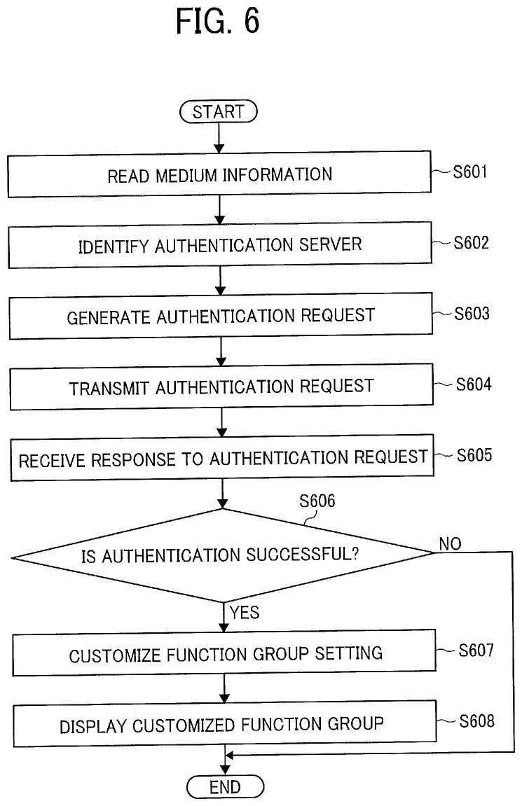

The authentication-server identifying unit 20h identifies an authentication server to perform the user authentication of the authentication servers 5A to 5D based on the medium type information read from the card C by the reading unit 20b. Details of the specific processing will be described later in the description of the flowchart illustrated in FIG. 6. The authentication-request generating unit 20d generates the authentication request for requesting the user authentication to the authentication server identified by the authentication-server identifying unit 20h. The authentication request includes, for example, the medium identification information read from the card C by the reading unit 20b. Alternatively, the authentication-request generating unit 20d may generate an authentication request in a format corresponding to each of the authentication servers. This format is, for example, a format corresponding to a web interface defined in advance by an authentication server. Specifically, for example, the medium identification information is described in a JavaScript Object Notation (JSON) format defined by the authentication server. The format of the web interface defined by each of the authentication servers is stored in, for example, the ROM 22 or the flash memory 24. The communication unit 20t transmits the generated authentication request to the identified authentication server.

In a case where the communication unit 20t receives the response to the authentication request, the function customizing unit 20e identifies one or more functions authorized to be used of the plurality of functions of the information processing apparatus 1 based on the response to the authentication request. Details of the specific processing will be described later in the description of the flowchart illustrated in FIG. 6. The UI display unit 20k displays an operation screen and icons representing various functions. The UI display unit 20k displays, for example, the one or more functions authorized to be used that are identified by the function customizing unit 20e in a selectable manner on the operation screen.

Main Body

The main body 10 includes a function executing unit 10a and a communication unit 10t. The communication unit 10t transmits and receives data (information) to and from the communication unit 20t of the operation device 20. The information transmitted from the operation device 20 includes, for example, an execution request for performing a function such as scan processing. The function executing unit 10a controls the engine 17 to perform the processing in accordance with the execution request for performing a function, received by the communication unit 10t. The processing in accordance with the execution request for performing a function is, for example, processing of scanning, copying, or printing.

Authentication Server

Each of the authentication servers 5A to 5D includes a user management unit 5a and a communication unit 5t. The communication unit St transmits and receives data (information) to and from the communication unit 20t of the operation device 20 via the network N. The information transmitted and received at this time includes, for example, an authentication request that is a request for user authentication, and a response (a success or a failure) to the authentication request. The user management unit 5a stores a plurality of unique sets of user identification information such as a user identifier (ID), a password, and the medium identification information. In addition, the user identification information may include function identification information for identifying a function authorized to be used for the user.

Each function of the embodiments described above may be implemented by one processing circuit or a plurality of processing circuits. Here, the “processing circuit or circuitry” in the present specification includes a programmed processor to execute each function by software, such as a processor implemented by an electronic circuit, and devices, such as an application specific integrated circuit (ASIC), a digital signal processor (DSP), a field programmable gate array (FPGA), and conventional circuit modules arranged to perform the recited functions.

Operation Procedure of Information Processing Apparatus

FIG. 6 is a flowchart for explaining an example of an operation procedure performed by the information processing apparatus according to the present embodiment. In S601, the reading unit 20b reads the medium identification information for identifying the card C and the medium type information for indicating the type of the card C from the card C held over the card reader 29.

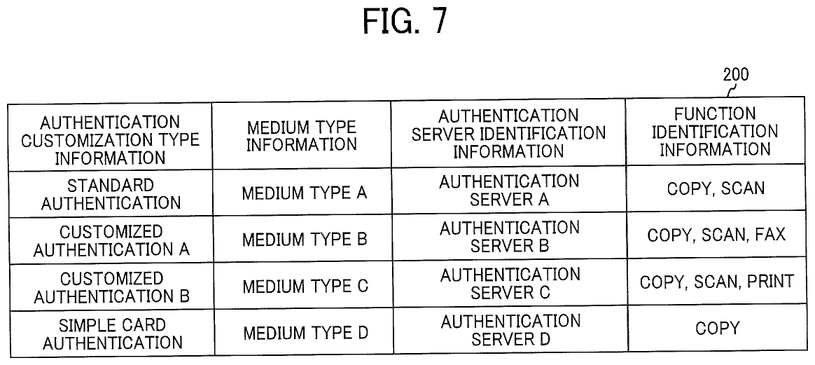

In S602, the authentication-server identifying unit 20h identifies an authentication server to perform user authentication of the authentication servers 5A to 5D based on the medium type information read from the card C by the reading unit 20b. Specifically, the authentication-server identifying unit 20h identifies the authentication server to perform the user authentication by referring to a table 200 illustrated in FIG. 7. The table 200 is stored in, for example, the ROM 22 or the flash memory 24. In the table 200, the authentication customization type information, the medium type information, authentication server identification information, and the function identification information are stored in association with one another.

The car type information indicates a type of recording medium storing the medium identification information. The medium type information indicates a standard of an IC card such as FELICA or MIFARE. Although the IC card is used as an example of the recording medium, the recording medium may also include other recording media such as a smartphone.

In such a case, the type of recording medium indicated by the medium type information (medium type information) may include, for example, a card and a smartphone. Hereinafter, even if the recording medium is an electronic device such as the smartphone, the electronic device may be referred to as a card. The authentication server identification information is information for identifying the authentication servers 5A to 5D. For example, the authentication servers A, B, C, and D in the table 200 are identification information for identifying the authentication servers 5A, 5B, 5C, and 5D, respectively.

In S603, the authentication-request generating unit 20d generates an authentication request for requesting the user authentication to the authentication server identified by the authentication-server identifying unit 20h. The authentication-request generating unit 20d generates the authentication request in a format corresponding to each of the plurality of authentication servers even if each of the plurality of authentication servers has a different format to receive the authentication request. Here, it is assumed that the medium type information read by the reading unit 20b is a medium type A and the authentication server identified by the authentication-server identifying unit 20h is the authentication server 5A (identified by the authentication server identification information the “authentication server A”). The authentication-request generating unit 20d reads the format of the web interface defined by the authentication server 5A from the formats of the web interface defined by each of the authentication servers 5A to 5D stored in the ROM 22 or the flash memory 24.

Then, the authentication-request generating unit 20d generates an authentication request including data described in the JSON format or the like in accordance with the read format of the web interface. At this point, the authentication-request generating unit 20d describes the medium identification information read from the card C by the reading unit 20b in the JSON format. Instead of the data described in the JSON format, the authentication request may include the medium identification information as an argument of a web application programming interface (API). As described above, the authentication-request generating unit 20d generates an authentication request in a format corresponding to each of the plurality of authentication servers even if each of the plurality of authentication servers has a different format to receive the authentication request. In addition, the authentication-request generating unit 20d generates the authentication request in a format of the web interface corresponding to each of the plurality of authentication servers even if each of the plurality of authentication servers has a different format of the web interface to receive the authentication request. In S604, the communication unit 20t transmits the authentication request generated by the authentication-request generating unit 20d to the authentication server 5A. In the above-described configuration, the information processing apparatus 1 selects an authentication server to perform the user authentication from the plurality of authentication servers 5A to 5D.

In S605, the communication unit 20t receives a response to the authentication request from the authentication server 5A. The response includes, for example, a result of the user authentication indicating whether or not the user authentication is successful. The authentication server 5A performs the user authentication based on the authentication request transmitted from the communication unit 20t of the operation device 20. For example, the user management unit 5a of the authentication server 5A determines whether or not the medium identification information included in the authentication request matches the medium identification information included in any set of the user identification information stored in the user management unit 5a. In a case where the two pieces of the medium identification information match, the response includes information indicating that the user authentication is successful. On the other hand, in a case where the two pieces of the medium identification information do not match, the response includes information indicating that the use authentication is unsuccessful.

In S606, the function customizing unit 20e determines whether or not the user authentication is successful based on the response that the communication unit 20t receives. Specifically, in a case where the response includes the information indicating that the user authentication is successful, the function customizing unit 20e determines that the user authentication is successful. On the other hand, in a case where the response includes the information indicating that the user authentication is unsuccessful, the function customizing unit 20e determines that the user authentication is unsuccessful. In the case where the function customizing unit 20e determines that the user authentication is unsuccessful (“NO” in S606), the process ends. On the other hand, in the case where the function customizing unit 20e determines that the user authentication is successful (“YES” in S606), the function customizing unit 20e identifies one or more functions authorized to be used of the plurality of functions of the information processing apparatus 1 in S607. This specific processing is performed by, for example, the following two methods.

One method is to use the function identification information in the table 200. The function customizing unit 20e identifies “COPY (a copying function)” and “SCAN (a scanning function)” as the one or more functions authorized to be used based on the function identification information stored in the table 200 in association with the medium type A. In this way, the information processing apparatus manages the function identification information. Thus, even when the system includes a plurality of information processing apparatuses, each of the plurality of information processing apparatuses independently manages a function authorized to be used for the user. For example, it is possible to authorize a user to use the functions of scanning, copying, and printing an MFP and authorize the same user to use the function of only scanning on another MFP.

The other method is to use the function identification information included in the response. In a case where the user management unit 5a of the authentication server 5A stores the function identification information for identifying a function authorized to be used for the user, the authentication server 5A transmits a response including the function identification information that is stored in association with the medium identification information included in an authentication request. In this way, the authentication server manages the function identification information. Thus, even when the system includes a plurality of information processing apparatuses, the authentication server collectively manages the function authorized to be used for the user on each of the plurality of information processing apparatuses. Then, the function customizing unit 20e identifies one or more functions identified by the function identification information included in the response as the one or more functions authorized to be used. For example, in a case where the function identification information included in the response indicates “COPY” and “SCAN,” the function customizing unit 20e identifies “COPY (a copying function)” and “SCAN (a scanning function)” as the one or more functions authorized to be used. In this way, the function customizing unit 20e identifies one or more functions authorized to be used of the plurality of functions based on the response transmitted from the authentication server. Thus, the functions authorized to be used for the user can be customized.

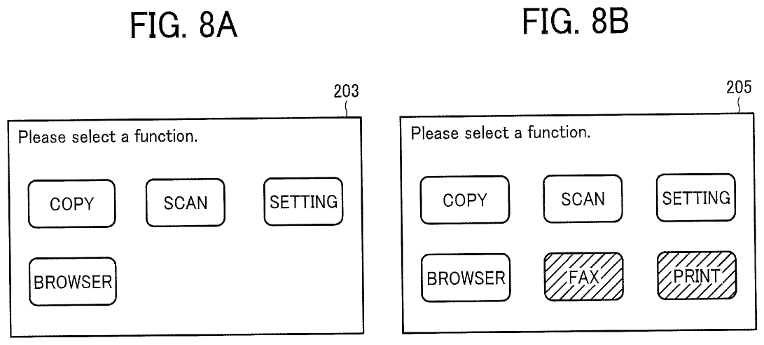

In S608, the UI display unit 20k displays “COPY (a copying function)” and “SCAN (a scanning function)” identified by the function customizing unit 20e as the one or more functions authorized to be used in a selectable manner on the operation panel 27. FIGS. 8A and 8B are diagrams each illustrating an example of a screen displayed on the operation panel 27 of the information processing apparatus according to the present embodiment.

As illustrated on a screen 203 of FIG. 8A, the UI display unit 20k displays the available functions of “COPY (a copying function)” and “SCAN (a scanning function)” in a selectable manner, and does not display unavailable functions of “FAX (a facsimile function)” and “Print (a printing function).” Alternatively, as illustrated on a screen 205 of FIG. 8B, the UI display unit 20k may display the unavailable functions of “FAX (a facsimile function)” and “Print (a printing function)” so as not to be selectable. Note that “SETTING (a setting function)” and “BROWSER (a browsing function)” are excluded from the customized function group in this example.

In this way, the UI display unit 20k displays only the functions authorized to be used for the user in a selectable manner. The user does not necessarily have to pay attention to which functions are available and which functions are unavailable when selecting a function.

Schematic Diagram Illustrating Operation

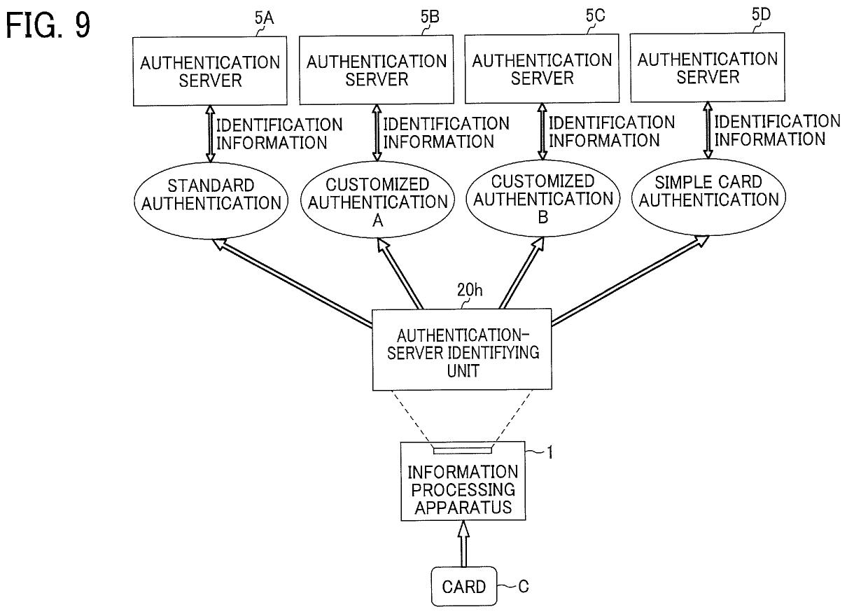

FIG. 9 is a schematic diagram illustrating an overview of an operation performed by the information processing apparatus according to the present embodiment. In this example, the information processing apparatus 1 selects one of the plurality of authentication servers 5A to 5D referring to the table 200 (see FIG. 7) that stores the medium type information and the authentication customization type information in association with each other, and causes the selected authentication server to perform user authentication. In the information processing apparatus 1, in a case where the reading unit 20b reads the medium type information from the card C, the authentication-server identifying unit 20h identifies one of the authentication servers 5A to 5D based on the medium type information of the card C and causes the identified authentication server to perform user authentication. In the above-described configuration, the authentication server to perform the user authentication is selected from the plurality of authentication servers 5A to 5D. For example, in a case where employees of different companies in a same office share the information processing apparatus 1, it is possible to cause different authentication servers to perform user authentication for the employees of each company by using IC cards whose medium type information is different for each company.

Variation

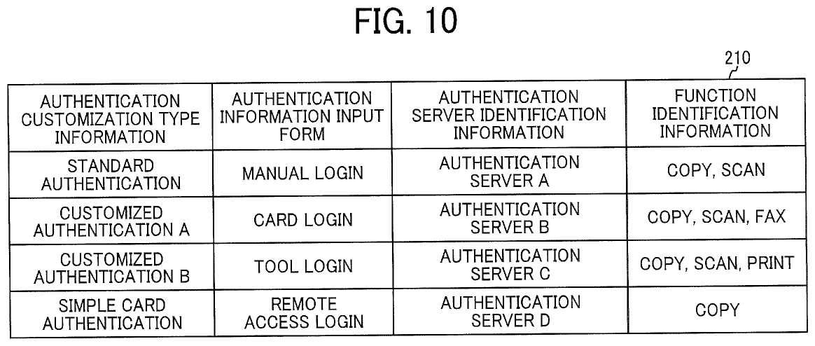

In the above-described embodiment, an authentication server to perform user authentication is identified using the medium type information of the IC card and the authentication server identification information stored in the table 200 in association with each other. Alternatively, the authentication server to perform the user authentication is identified using, instead of the medium type information of the IC card, an authentication information input form indicating an input form of login that is stored in association with the authentication server identification information. The authentication-server identifying unit 20h identifies an authentication server to perform user authentication of the authentication servers 5A to 5D based on the authentication information input form. Specifically, the authentication-server identifying unit 20h identifies the authentication server to perform the user authentication by referring to a table 210 illustrated in FIG. 10. The table 210 is stored in, for example, the ROM 22 or the flash memory 24. As illustrated in FIG. 10, the authentication customization type information, the authentication information input form, authentication server identification information, and the function identification information are stored in the table 210 in association with one another. Examples of the authentication information input form include a manual login, a card login, a tool login, and a remote access login. The manual login represents a login method of inputting the user identification information such as a user ID and a password using a keyboard, a software keyboard, and a mouse. The card login represents a login method of reading the medium identification information stored in the card C by the reading unit 20b. The tool login represents a login method of activating a software tool and inputting the user identification information such as a user ID and a password into a particular section provided by the software tool. The remote access login represents a login method of accessing a particular server from an external terminal and inputting the user identification information such as a user ID and a password into a particular section provided by the particular server.

First Aspect

The information processing apparatus 1 according to a first aspect is connected to the plurality of authentication servers 5A to 5D via the network N and includes a memory, a reading unit (e.g., the reading unit 20b), an authentication-server identifying unit (e.g., the authentication-server identifying unit 20h), an authentication-request generating unit (e.g., the authentication-request generating unit 20d) and a communication unit (e.g., the communication unit 20t). The memory stores, for each of a plurality of types of recording medium (e.g., the card C) used for user authentication, the authentication server identification information identifying an authentication server to perform user authentication using the recording medium in association with the medium type information of the recording medium. The authentication server identification information identifies an authentication server to perform the user authentication of the plurality of authentication servers 5A to 5D. The medium type information indicates a type of the recording medium used for the user authentication. The reading unit reads, from the recording medium, the medium identification information that identifies the recording medium and the medium type information that indicates the type of the recording medium. The authentication-server identifying unit identifies the authentication server to perform the user authentication of the plurality of authentication servers 5A to 5D based on the medium type information read by the reading unit and the authentication server identification information stored in the memory. The authentication-request generating unit generates an authentication request for requesting the user authentication to the identified authentication server. The authentication request includes the medium identification information read by the reading unit. The communication unit transmits the authentication request generated by the authentication-request generating unit to the authentication server identified of the plurality of authentication servers 5A to 5D by the authentication-server identifying unit via the network N. In the configuration according to the present aspect, the information processing apparatus 1 selects an authentication server to perform user authentication from the plurality of authentication servers 5A to 5D.

Second Aspect

The information processing apparatus 1 according to the first aspect has a plurality of functions and includes a display control unit (e.g., the UI display unit 20k) that displays one or more functions authorized to be used from the plurality of functions in a selectable manner on a display based on a response transmitted from the authentication server to which an authentication request is sent. According to the present aspect, the display control unit displays only one or more functions authorized to be used for a user in a selectable manner. The user does not necessarily have to pay attention to which functions are available and which functions are unavailable when selecting a function.

Third Aspect

The information processing apparatus 1 according to the second aspect further includes a function customizing unit (e.g., the function customizing unit 20e) that identifies the one or more functions authorized to be used of the plurality of functions based on the response transmitted from the authentication server to which the authentication request is sent. The display control unit (e.g., the UI display unit 20k) displays the one or more functions identified by the function customizing unit in a selectable manner on the display. According to the present aspect, the function customizing unit identifies one or more functions authorized to be used of the plurality of functions based on a response transmitted from the authentication server. Thus, the functions authorized to be used for a user can be customized.

Fourth Aspect

In the information processing apparatus 1 according to the third aspect, the response includes the function identification information identifying the one or more functions authorized to be used of the plurality of functions, and the function customizing unit (e.g., the function customizing unit 20e) identifies the one or more functions authorized to be used of the plurality of functions based on the function identification information included in the response. This aspect corresponds to the above-described method to use the function identification information included in the response.

Fifth Aspect

In the information processing apparatus 1 according to the third aspect, the memory further stores, for each of a plurality of types of recording medium (e.g., the card C) used for user authentication, the authentication server identification information identifying an authentication server to perform user authentication using the recording medium in association with the medium type information of the recording medium. The function customizing unit (e.g., the function customizing unit 20e) identifies the one or more functions authorized to be used of the plurality of functions based on the function identification information stored in the memory in association with the read medium type information. According to the present aspect, the information processing apparatus manages the function identification information. Thus, even when the system includes a plurality of information processing apparatuses, each of the plurality of information processing apparatuses independently manages the function authorized to be used for the user. For example, it is possible to authorize a user to use the functions of scanning, copying, and printing on an MFP and authorize the same user to use the function of only scanning on another MTP.

Sixth Aspect

In the information processing apparatus 1 according to any one of the first to fifth aspects, the authentication-request generating unit (e.g., the authentication-request generating unit 20d) generates an authentication request specific to the identified authentication server. According to the present aspect, the authentication-request generating unit generates an authentication request in a format corresponding to each of the plurality of authentication servers even if each of the plurality of authentication servers has a different format to receive the authentication request.

Seventh Aspect

In the information processing apparatus 1 according to the sixth aspect, the authentication request has a format corresponding to a web interface defined in advance by an authentication server. According to the present aspect, the authentication-request generating unit generates the authentication request in a format of the web interface corresponding to each of the plurality of authentication servers even if each of the plurality of authentication servers has a different format of the web interface to receive the authentication request.

Eighth Aspect

An information processing method according to the present disclosure, which is performed by the information processing apparatus 1, includes a reading step (S601), an authentication server identifying step (S602), an authentication request generating step (S603) and a transmitting step (S604). In the reading step, the reading unit reads, from the recording medium (the card C), the medium identification information that identifies the recording medium and the medium type information that indicates the type of the recording medium. In the authentication server identifying step, the authentication-server identifying unit identifies the authentication server to perform user authentication of the plurality of authentication servers 5A to 5D based on the authentication server identification information stored in a memory and the medium type information read in the reading step. The authentication server identification information is stored in the memory, for each of a plurality of types of recording medium used for user authentication, in association with the medium type information of the recording medium, and identifies an authentication server to perform the user authentication of the plurality of authentication servers 5A to 5D that are connected to the information processing apparatus 1 via the network N. In the authentication request generating step, the authentication-request generating unit generates an authentication request for requesting the user authentication to the authentication server identified in the authentication-server identifying step. The authentication request includes the medium identification information read in the reading step. In the transmitting step, the communication unit transmits the authentication request generated in the authentication request generating step to the authentication server identified of the plurality of authentication servers 5A to 5D in the authentication server identifying step via the network N. In the configuration according to the present aspect, the information processing apparatus 1 selects an authentication server to perform user authentication from the plurality of authentication servers 5A to 5D.

Ninth Aspect

The information processing method according to the eighth aspect further includes a display control step (S608). In the display control step, the display control unit displays one or more functions authorized to be used from the plurality of functions of the information processing apparatus 1 in a selectable manner on a display based on a response transmitted from the authentication server to which the authentication request is sent. According to the present aspect, the display control unit displays only a function authorized to be used for a user in a selectable manner. The user does not necessarily have to pay attention to which functions are available and which functions are unavailable when selecting a function.

Tenth Aspect

A non-transitory recording medium according to the tenth aspect storing a plurality of program codes which, when executed by one or more processors, causes the information processing apparatus 1 to perform a method, the method includes a reading step (S601), an authentication server identifying step (S602), an authentication request generating step (S603) and a transmitting step (S604). In the reading step, the reading unit reads, from the recording medium (the card C), the medium identification information that identifies the recording medium and the medium type information that indicates the type of the recording medium. In the authentication server identifying step, the authentication-server identifying unit identifies the authentication server to perform user authentication of the plurality of authentication servers 5A to 5D based on the authentication server identification information stored in a memory and the medium type information read in the reading step. The authentication server identification information is stored in the memory, for each of a plurality of types of recording medium used for user authentication, in association with the medium type information of the recording medium, and identifies an authentication server to perform the user authentication of the plurality of authentication servers 5A to 5D that are connected to the information processing apparatus 1 via the network N. In the authentication request generating step, the authentication-request generating unit generates an authentication request for requesting the user authentication to the authentication server identified in the authentication-server identifying step. The authentication request includes the medium identification information read in the reading step. In the transmitting step, the communication unit transmits the authentication request generated in the authentication request generating step to the authentication server identified of the plurality of authentication servers 5A to 5D in the authentication server identifying step via the network N. In the configuration according to the present aspect, the information processing apparatus 1 selects an authentication server to perform user authentication from the plurality of authentication servers 5A to 5D.

Eleventh Aspect

The non-transitory recording medium of the tenth aspect causes the processors to further perform, in the method, a display control step (S608). In the display control step, the display control unit displays one or more functions authorized to be used from the plurality of functions of the information processing apparatus 1 in a selectable manner on a display based on a response transmitted from the authentication server to which the authentication request is sent. According to the present aspect, the display control unit displays only a function authorized to be used for a user in a selectable manner. The user does not necessarily have to pay attention to which functions are available and which functions are unavailable when selecting a function.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus comprising:
a memory that stores, for each of a plurality of types of recording medium used for user authentication, authentication server identification information identifying an authentication server to perform user authentication using the recording medium in association with medium type information of the recording medium; and
circuitry configured to:
read, from a recording medium used for user authentication, medium identification information identifying the recording medium and medium type information indicating a type of the recording medium;
identify an authentication server to perform user authentication based on authentication server identification information stored in the memory in association with the read medium type information;
generate an authentication request for requesting the user authentication to the identified authentication server, the authentication request including the read medium identification information; and
transmit the generated authentication request to the identified authentication server via a network.

2. The information processing apparatus according to claim 1, wherein:
the information processing apparatus has a plurality of functions; and
the circuitry is further configured to display, on a display, information on one or more functions of the plurality of functions that are authorized to be used in a selectable manner based on a response transmitted from the authentication server to which the authentication request is sent.

3. The information processing apparatus according to claim 2, wherein the circuitry is further configured to:
identify the one or more functions authorized to be used from the plurality of functions based on the response transmitted from the authentication server to which the authentication request is sent.

4. The information processing apparatus according to claim 3, wherein:
the response includes function identification information identifying each of the one or more functions authorized to be used; and
the circuitry is configured to identify the one or more functions authorized to be used based on the function identification information included in the response.

5. The information processing apparatus according to claim 4, wherein:
the memory further stores the function identification information in association with the medium type information, for each of the plurality of types of recording medium; and
the circuitry is configured to identify the one or more functions authorized to be used based on the function identification information stored in the memory in association with the read medium type information.

6. The information processing apparatus according to claim 1, wherein the circuitry is configured to generate the authentication request specific to the identified authentication server.

7. The information processing apparatus according to claim 6, wherein the authentication request includes a format corresponding to a web interface defined in advance by the identified authentication server.

8. An information processing method, the method comprising:
reading, from a recording medium used for user authentication, medium identification information identifying the recording medium and medium type information indicating a type of the recording medium;
identifying an authentication server to perform user authentication, based on authentication server identification information stored in a memory in association with the read medium type information of the recording medium;
generating an authentication request for requesting the user authentication to the identified authentication server, the authentication request including the read medium identification information; and
transmitting the generated authentication request to the identified authentication server via a network.

9. The information processing method according to claim 8, further comprising displaying, on a display, information on one or more functions of the plurality of functions that are authorized to be used in a selectable manner based on a response transmitted from the authentication server to which the authentication request is sent.

10. A non-transitory recording medium storing a plurality of program codes which, when executed by one or more processors, causes the processors to perform a method, the method comprising:
reading, from a recording medium used for user authentication, medium identification information identifying the recording medium and medium type information indicating a type of the recording medium;
identifying an authentication server to perform user authentication, based on authentication server identification information stored in a memory in association with the read medium type information of the recording medium;
generating an authentication request for requesting the user authentication to the identified authentication server, the authentication request including the read medium identification information; and
transmitting the generated authentication request to the identified authentication server via a network.

11. The non-transitory recording medium according to claim 10, wherein the method further includes displaying, on a display, information on one or more functions of the plurality of functions that are authorized to be used in a selectable manner based on a response transmitted from the authentication server to which the authentication request is sent.
